(19) United States
(12) Patent Application Publication
(10) Pub. No.: US 2004/0233130 A1
(43) Pub. Date: Nov. 25, 2004

(54) Method of driving plasma display panel

(75) Inventor: Ryo Suzue, Yamanashi-ken (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/842,493

(22) Filed: May 11, 2004

(30) Foreign Application Priority Data
May 21, 2003 (JP) 2003-143295

(51) Int. Cl. G09G 3/28

(52) U.S. Cl. 345/60

(57) ABSTRACT

In a plasma display panel having a partition wall member provided for defining discharge cells and constituted by covering a metal base with an insulation layer, during an addressing period of the image display period after the completion of the reset discharge, scan pulses SP are applied to the row electrodes and data pulses DP1 to DPn are applied to the column electrodes for the selection of the discharge cells in which a sustaining discharge will be produced for the creation of an image by means of the discharge emission. During this addressing discharge period Wc, the metal-made base of the partition wall member is grounded to be set at a predetermined potential.

### BACKGROUND OF THE INVENTION

1. Field of the Invention

This invention relates to a method of driving a surface-discharge-type AC plasma display panel.

The present application claims priority from Japanese Application No. 2003-143295, the disclosure of which is incorporated herein by reference.

2. Description of the Related Art

FIGS. 1 to 3 schematically illustrate the cell structure of the conventional surface-discharge-type AC plasma display panel (hereinafter referred to as “PDP”). FIG. 1 is a front view of the PDP. FIG. 2 and FIG. 3 are respectively sectional views taken along the V-V line and the W-W line in FIG. 1.

The PDP shown in FIGS. 1 to 3 has a front glass substrate 1 on the rear-facing face of which are formed a plurality of row electrode pairs (X, Y) each extending in the row direction (i.e. the right-left direction in FIG. 1) and regularly arranged in the column direction to form display lines L; a dielectric layer 2 overlying the row electrode pairs (X, Y); and a protective layer 3 overlying the dielectric layer 2.

The front glass substrate 1 is located opposite a back glass substrate 4 with a discharge space S in between. On the inner face of the back glass substrate 4 opposing the front glass substrate 1, a plurality of column electrodes D extend in the column direction and are regularly arranged in the row direction so as to form discharge cells C in the discharge space S at the respective intersections with the row electrode pairs (X, Y).

A partition wall member 5, which is formed approximately in a grid shape of vertical walls 5A extending in the column direction and transverse walls 5B extending in the row direction, is provided between the front glass substrate 1 and the back glass substrate 4, so that the discharge space S between the front glass substrate 1 and the back glass substrate 4 is partitioned into the discharge cells C in the row direction and the column direction.

Further, additional dielectric layers 2A each project from the front glass substrate 1 toward the back glass substrate 4 in a position opposite to the transverse wall 5B of the partition wall member 5. The additional dielectric layer 2A is in contact with the transverse wall 5B to block the adjoining discharge cells C in the column direction from each other.

In the individual discharge cells C, red (R), green (G) and blue (B) colored phosphor layers 6 are provided and arranged in order in the column direction.

For the generation of an image in the PDP, in an addressing period subsequent to a reset period, an addressing discharge is selectively produced between the column electrode D and one row electrode in the row electrode pair (X, Y) (in this case, the row electrode Y) in the discharge cell C. As a result, the light emitting cells (the discharge cells having wall charges generated on the dielectric layer 2) and the non-light emitting cells (the discharge cells having no wall charges generated on the dielectric layer 2) are distributed over the panel surface in accordance with the image to be displayed.

After completion of the addressing discharge in the addressing period, in a sustaining discharge period, in all the display lines L, a discharge-sustaining pulse is applied alternately to the row electrodes X and Y in each row electrode pair (X, Y). Thereupon, a sustain discharge is produced between the row electrodes X and Y in each light emitting cell with every application of the discharge-sustaining pulse.

As a result of the sustain discharge in each light emitting cell, ultraviolet light is generated from a discharge gas sealed in the discharge space S, and then excites each of the red-, green- and blue-colored phosphor layers 6 individually provided in the discharge cell C for the emission of visible light to form the image displayed.

In such a PDP, the partition wall member 5 has the function of preventing the occurrence of a false discharge caused by interference from discharge between the adjoining discharge cells C in the row direction and the column direction. Therefore, the partition wall member 5 needs to have electrical insulation properties.

Conventionally, the partition wall member for defining the discharge cells C of the PDP is formed by the use of sandblasting techniques after the processes of coating with a low-melting glass paste and firing. This method has the problem of high manufacturing costs.

In a PDP proposed as an alternative, as illustrated in FIG. 4, the inside of the partition wall member 15 is formed of a conductive metal base 15a, and the surface thereof is covered with a dielectric insulation layer 15b formed of dielectric materials having electrical insulation properties. Thereby the PDP is capable of ensuring the necessary electrical insulation properties and reducing the manufacturing costs.

Such a structure of a conventional PDP is described in Japanese Patent Publication No. 2741418.

If the partition wall member 5 is formed of insulating materials such as a glass material as in the case of the PDP illustrated in FIGS. 1 to 3, when the addressing discharge voltage is applied between the row electrode Y and the column electrode D, only thing interposed between the electrodes is the insulating material. Hence, an electric field occurs concentratedly inside the discharge cell C, so that the addressing-voltage margin (Vofs margin) is substantially stable.

However, in the PDP having a metallic partition wall member 15 as illustrated in FIG. 4, when the addressing discharge voltage is applied between the row electrode Y and the column electrode D, a potential is produced between the partition wall member 15 having the electrical conductivity and the row electrode Y and column electrode D.

For this reason, because the partition wall member 15 has the potential, a false discharge is also likely to occur in another discharge cell C located around the discharge cell C subjected to the addressing discharge.

Further, a potential occurring in the partition wall member 15 varies with the number of discharge cells C subject to the addressing discharge (i.e. the number of selected discharge cells C), and the kinds of discharge cells C (i.e. the colors of the phosphor layers 6) selected in accordance with the combinations of red, green and/or blue colors for reproducing various colors. This leads to a change in the direction of the addressing-voltage margin (Vofs margin) decreasing.

For example, if the selective erasure method is employed for selecting the discharge cells C, when a monochrome is reproduced, the wall charge accumulated on the dielectric layer 2 in the discharge cell C is easily erased so that the addressing voltage margin is relatively wide. However, when a complementary color is reproduced, the erasing of the wall charge accumulated on the dielectric layer 2 in the discharge cell C becomes difficult so that the addressing voltage margin is decreased.

### SUMMARY OF THE INVENTION

The present invention is essentially designed to solve the problems associated with the surface-discharge-type AC plasma display panels having the metal-made partition wall member as described hitherto.

It is, therefore, an object of the present invention to provide a method of driving a plasma display panel having a metal-made partition wall member without the occurrence of a false addressing discharge and a decrease in the addressing voltage margin.

To achieve this object, the present invention provides a method of driving a plasma display panel comprising a pair of substrates facing each other with a discharge space in between, a plurality of row electrode pairs, a plurality of column electrodes arranged to intersect with the row electrode pairs, and a partition wall member provided for defining unit light emission areas each formed in the proximity of the intersection of the row electrode pair and the column electrode in the discharge space, the partition wall member being formed of a metal-made base material covered with an insulation layer. The driving method comprises a step of setting a potential on the metal-made base material of the partition wall member at a predetermined potential during an addressing period of a image display period, in which an addressing discharge is produced by the application of a scan pulse to one row electrode in the row electrode pair and the application of a data pulse to the column electrode to select the unit light emission areas in which a sustaining discharge is to be produced in order to emit light for the generation of an image.

In this method of driving a plasma display panel in which the partition wall member for defining the unit light emission areas formed in the discharge space between the pair of substrates is made of a metal-made base covered with an insulation layer, after the completion of the reset discharge, during the addressing discharge period of the image display period, a scan pulse is applied to one row electrode in the row electrode pair and a data pulse is applied to the column electrode in order to select the unit light emission areas in which a sustaining discharge is to be produced for the creation of an image by means of the discharge emission. During this addressing discharge period, the metal-made base of the partition wall member is grounded so that the potential on the partition wall member is set at a predetermined potential.

With this method of driving the plasma display panel, because the potential on the partition wall member is set at a predetermined potential during the addressing period of the image display period, the potential on the partition wall member becomes equal over the entire panel surface, resulting in the prevention of the occurrence of a false discharge in another unit light emission area in the vicinity of the unit light emission area in which the addressing discharge is produced.

Further, because the potential on the partition wall member is set at a predetermined potential and therefore is not varied in potential with the number of unit light emission areas subject to the addressing discharge (i.e. the number of selected unit light emission areas), the kind of unit light emission area (i.e. the color of the phosphor layer) selected in accordance with the combinations of red, green and/or blue colors for reproducing various colors, and the like. Accordingly, the decrease in the addressing-voltage margin which is caused by using a metal-made base to form the partition wall member is prevented.

These and other objects and features of the present invention will become more apparent from the following detailed description with reference to the accompanying drawings.

### BRIEF DESCRIPTION OF THE DRAWINGS

FIG. 1 is a schematic front view of the structure of a conventional plasma display panel.

FIG. 2 is a sectional view taken along the V-V line in FIG. 1.

FIG. 3 is a sectional view taken along the W-W line in FIG. 1.

FIG. 4 is a front view illustrating the structure of a conventional plasma display panel having a metal-made partition wall member.

FIG. 5 is a front view illustrating an example in an embodiment of the structure of a plasma display panel employing the application of a driving method according to the present invention.

FIG. 6 is a sectional view taken along the V1-V1 line in FIG. 5.

FIG. 7 is a sectional view taken along the V2-V2 line in FIG. 5.

FIG. 8 is a sectional view taken along the W1-W1 line in FIG. 5.

FIG. 9 is a sectional view taken along the W2-W2 line in FIG. 5.

FIG. 10 is a front view illustrating the structure of the connection between a partition wall member and a grounding wire in the example in FIG. 5.

FIG. 11 is a sectional view taken along the V3-V3 line in FIG. 10.

FIG. 12 is a timing chart illustrating the timing of the application of a potential to the partition wall member in the example in FIG. 5.

FIG. 13 is a block diagram illustrating the configuration of drivers for applying the potential in the example in FIG. 5.

FIG. 14 is a front view illustrating another example of the structure of a plasma display panel employing the application of a driving method according to the present invention.

FIG. 15 is a sectional view taken along the V4-V4 line in FIG. 14.

FIG. 16 is a sectional view taken along the W3-W3 line in FIG. 14.

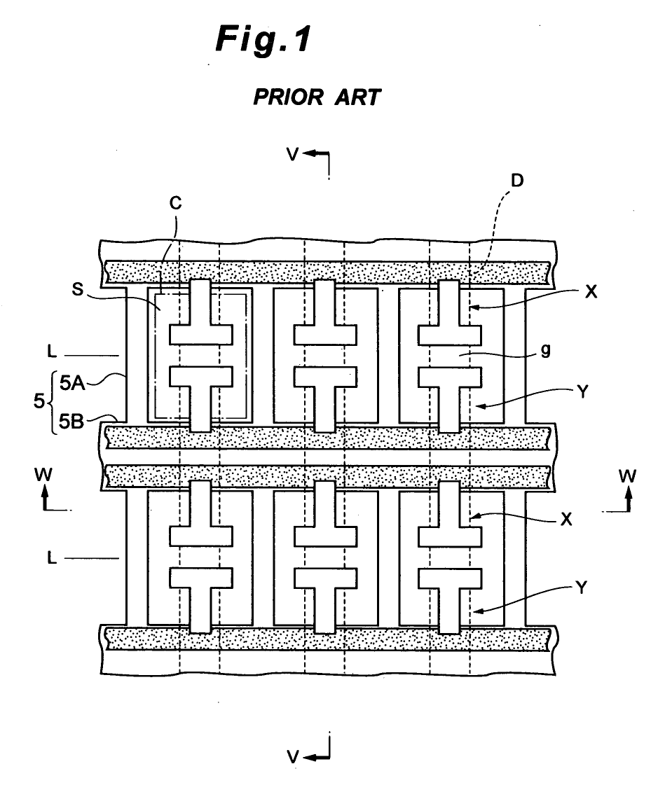

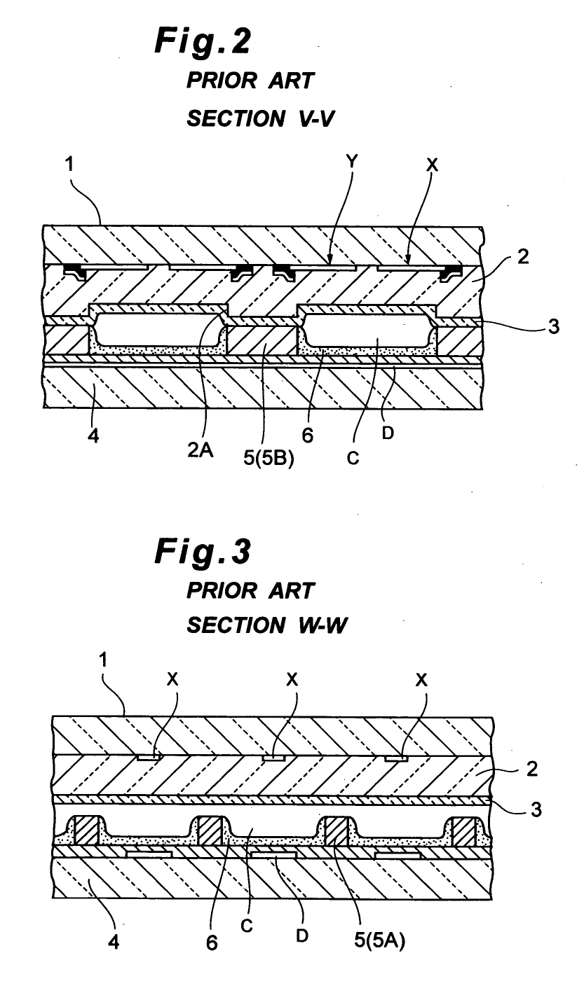

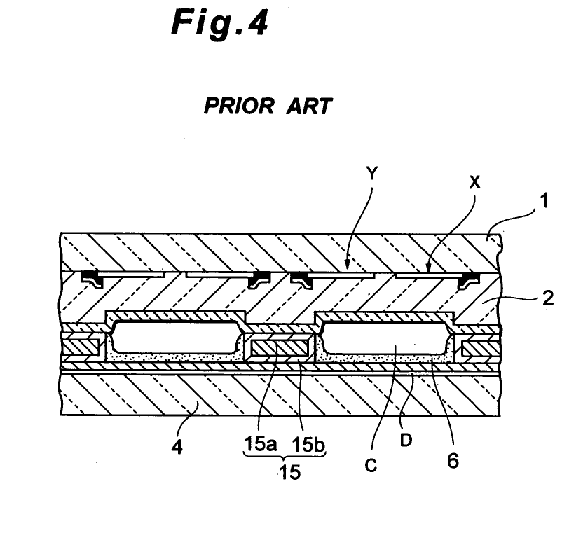

### DETAILED DESCRIPTION OF THE PREFERRED EMBODIMENT

A preferred embodiment according to the present invention will be described below in detail with reference to the accompanying drawings.

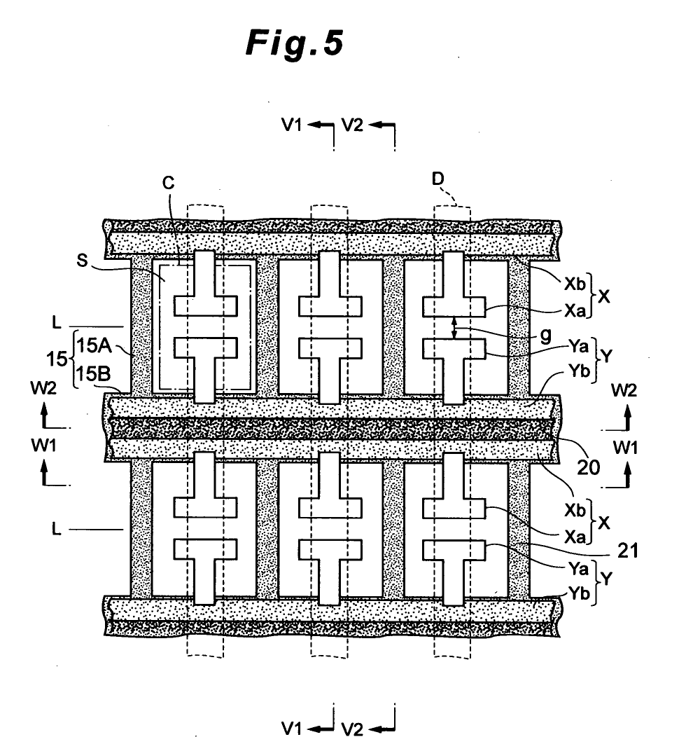

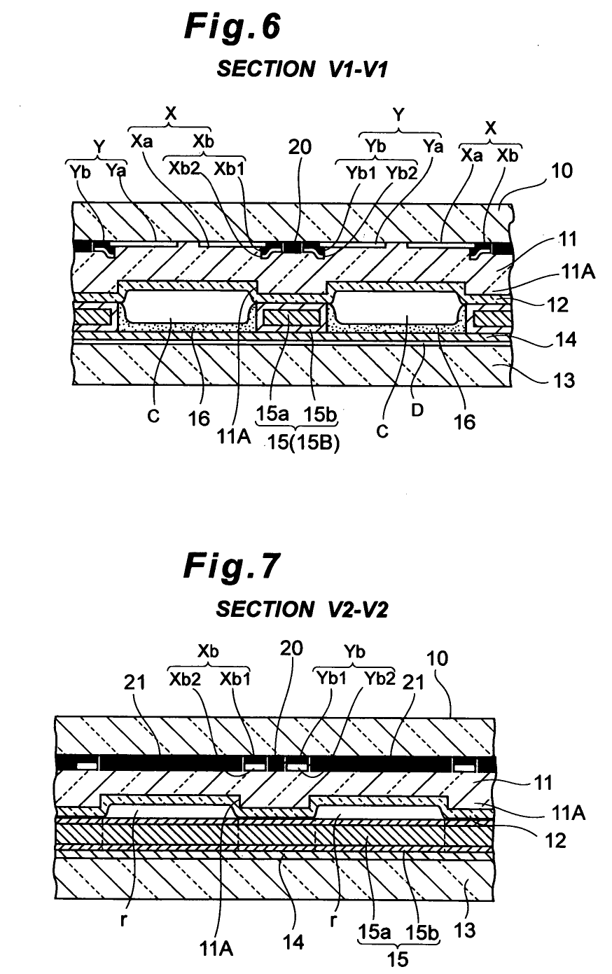

FIG. 5 to FIG. 9 illustrate an example of the structures of a plasma display panel (hereinafter referred to as “PDP”) driven by use of the method according to the present invention: FIG. 5 is a schematic front view of the relationship between a row electrode pair and a partition wall member of the PDP and FIGS. 6, 7, 8 and 9 are sectional views respectively taken along the V1-V1 line, the V2-V2 line, the W1-W1 line and the W2-W2 line as shown in FIG. 5.

In FIG. 5 to FIG. 9, a plurality of row electrode pairs (X, Y) each extending in a row direction of a front glass substrate 10 (i.e. the right-left direction in FIG. 5) are arranged parallel to each other on the rear-facing face of the front glass substrate 10 serving as the display screen.

The row electrode X is composed of T-shaped transparent electrodes Xa formed of a transparent conductive film made of ITO or the like, and a bus electrode Xb formed of a metal film. The bus electrode Xb extends in the row direction of the front glass substrate 10 and is connected to the proximal ends (corresponding to the foot of the T shape) of the transparent electrodes Xa.

Likewise, the row electrode Y is composed of T-shaped transparent electrodes Ya formed of a transparent conductive film made of ITO or the like, and a bus electrode Yb formed of a metal film. The bus electrode Yb extends in the row direction of the front glass substrate 10 and is connected to the proximal ends (corresponding to the foot of the T shape) of the transparent electrodes Ya.

The row electrodes X and Y are arranged in alternate positions in the column direction of the front glass substrate 10 (i.e. the vertical direction in FIG. 5). In each row electrode pair, the transparent electrodes Xa and Ya, which are lined up along the corresponding bus electrodes Xb and Yb at regular intervals, extend in the direction toward its counterpart in the row electrode pair, so that the two widened-tops (corresponding to the head of the T shape) of the transparent electrodes Xa and Ya face each other with a discharge gap g having a required width in between.

Each of the bus electrodes Xb and Yb is formed in a double layer structure consisting of a black conductive layer Xb1 (a black conductive layer Yb1) positioned close to the display screen and a main conductive layer Xb2 (a main conductive layer Yb2) positioned behind this.

On the rear-facing face of the front glass substrate 10, black-colored light absorption layers (light-shield layers) 20 are provided and each extend in the row direction along and between the back-to-back bus electrodes Xb, Yb of the respective row electrode pairs (X, Y) adjoining to each other in the column direction. Further black-colored light absorption layers (light-shield layers) 21 are provided and each extend in the column direction so as to pass through mid-positions between the side-by-side transparent electrodes Xa and the side-by-side transparent electrodes Ya corresponding arranged along the bus electrodes Xb and Yb of each row electrode X and Y in the row direction.

The light absorption layer 20 is opposite to a transverse wall of a partition wall member which will be described in detail, and the light absorption layer 21 is opposite to a vertical wall of the partition wall member.

On the rear-facing face of the front glass substrate 10, further, a dielectric layer 11 covers the row electrode pairs (X, Y). Yet further, additional dielectric layers 11A are provided on the rear-facing face of the dielectric layer 11. Each of the additional dielectric layers 11A projects from the rear-facing face of the dielectric layer 11 and extends parallel to the back-to-back bus electrodes Xb, Yb of the adjoining row electrode pairs (X, Y) and opposite to the back-to-back bus electrodes Xb, Yb concerned and the area between the back-to-back bus electrodes Xb, Yb.

The rear-facing faces of the dielectric layer 11 and the additional dielectric layers 11A are covered with an MgO made protective layer 12.

The front glass substrate 10 is located parallel to a back glass substrate 13. On the front-facing face of the back glass substrate 13, column electrodes D are arranged parallel to each other at predetermined intervals. Each of the column electrodes D extends in a direction at right angles to the row electrode pair (X, Y) (i.e. in the column direction) in a position opposite to the paired transparent electrodes Xa and Ya of each of the row electrode pairs (X, Y).

The column electrodes D are covered with a column-electrode protective layer (dielectric layer) 14 provided on the front-facing face of the back glass substrate 13 facing toward the front glass substrate 10. Then a partition wall member 15 is provided on the column-electrode protective layer 14. The partition wall member 15 is formed approximately in a grid shape having vertical walls 15A each extending in the column electrode and opposite an area between the column electrodes D arranged parallel to each other and transverse walls 15B each extending in the row direction and opposite the additional dielectric layer 11A.

The partition wall member 15 is constituted by covering the surface of an approximate grid-shaped conductive metal-base 15a with a dielectric insulation layer 15b which is formed of a dielectric material having the electrical insulation properties.

The grid-shaped partition wall member 15 partitions the discharge space S defined between the front glass substrate 10 and the back glass substrate 13 into areas corresponding the position of the paired transparent electrodes Xa and Ya in each row electrode pair (X, Y) to individually form quadrangular discharge cells C.

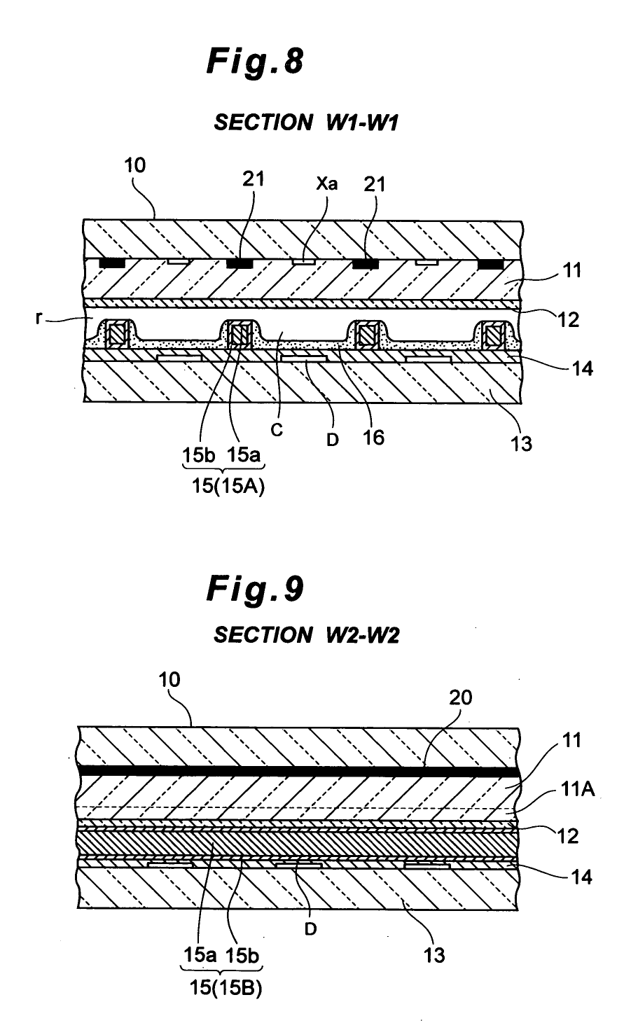

The front-facing face of the vertical wall 15A of the partition wall member 15 is out of contact with the protective layer 12 (see FIGS. 7 and 8) so as to form a clearance r therebetween. The front-facing face of the transverse wall 15B is in contact with a portion of the protective layer 12 overlying the additional dielectric layer 11A to block adjoining discharge cells C from each other in the column direction (FIGS. 6 and 9).

In each discharge cell C, a phosphor layer 16 is laid on all five faces facing the discharge space, i.e. the face of the column-electrode protective layer 14 and the side faces of the vertical walls 15A and the transverse walls 15B of the partition wall member 15. The three primary colors, red (R) green (G) and blue (B) are applied individually to the phosphor layers 16 such that the red (R), green (G) and blue (B) discharge cells C are arranged in order in the row direction.

The discharge space S between the front glass substrate 10 and the back glass substrate 13 is filled with a discharge gas.

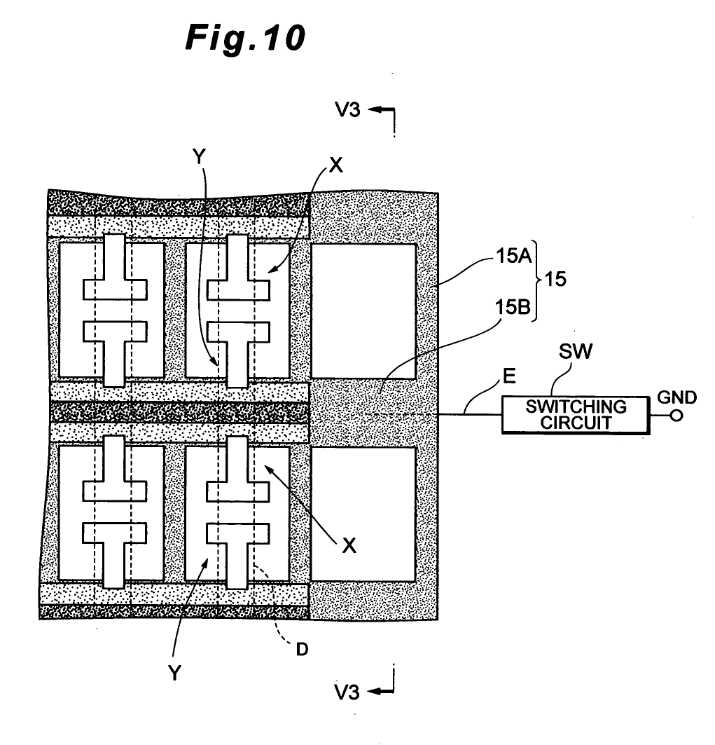

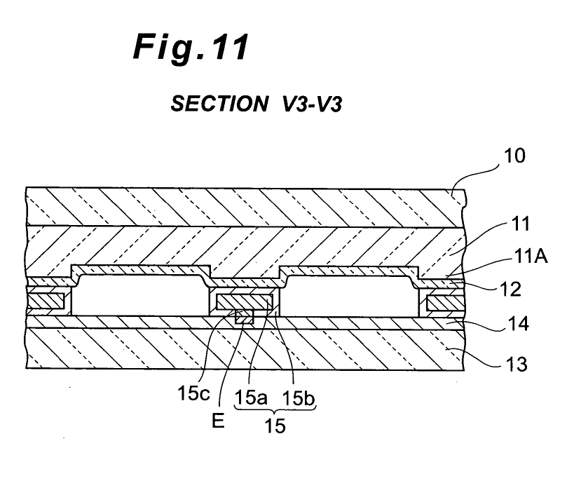

FIG. 10 is a plan view illustrating a non-display area located in the margin portion of the surface of the PDP structured as described hitherto. FIG. 11 is a sectional view taken along the V3-V3 line in FIG. 10.

In the non-display area of the PDP shown in FIGS. 10 and 11, a grounding wire E connected to a switching circuit SW is drawn from a portion of the column-electrode protective layer 14 beneath the transverse wall 15B of the partition wall member 15.

The dielectric insulation layer 15b covering the metal base 15a is not formed in a portion of the partition wall member 15 facing the grounding wire E, so that in this portion the metal base 15a is electrically connected to the grounding wire E by means of a conductive paste 15c filled therebetween.

The switching circuit SW is switched between positions for the connecting and disconnecting between the grounding wire E and a GND terminal provided in the PDP.

Each of the row electrode pairs (X, Y) forms a display line (row) L of the matrix display screen of the PDP.

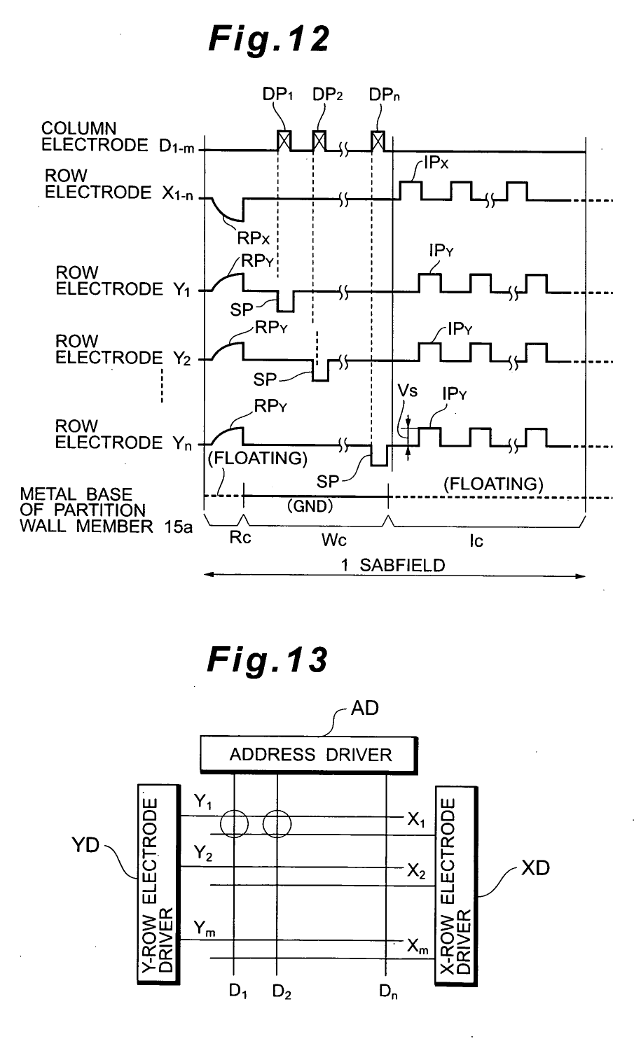

FIG. 12 is a timing chart of the application of a pulse when the PDP is operated for generating an image by the use of the method of driving a PDP according to the embodiment of the present invention.

The method of driving the PDP in the embodiment of the present invention is now described with reference to the timing chart in FIG. 12.

Note that there are generally two types of the driving methods for the PDP: the selective erasure address method (i.e. the driving method of selectively erasing the wall charges in the discharge cells C in accordance with the image data by means of the addressing discharge in the addressing period after the completion of the writing operation in which wall charges are generated simultaneously in all the discharge cells C by means of the reset discharge in the reset period) and the selective writing address method (i.e. the driving method of selectively forming wall charges in the discharge cells C in accordance with the image data by means of the addressing discharge in the addressing period after the wall charges are simultaneously erased from all the discharge cells C by means of the reset discharge in the reset period). The following describes the method of driving the PDP using the selective erasure address method, but even if the selective writing address method is employed, the PDP can be driven similarly.

FIG. 12 illustrates timing of the application of pulse in a subfield of the subfields constituting a one field display period for the gradation display when the selective erasure address method is used.

Referring to FIG. 12, in the reset period Rc, reset pulses RPx, RPy are applied to the row electrodes X, Y for producing a reset discharge.

At this point, the potential on the metal base 15a of the partition wall member 15 is in a floating state because the switching circuit SW is switched to a position for establishing disconnection between the grounding wire E and the GND terminal.

In the addressing period Wc subsequent to the reset period Rc, data pulses DP1 to DPn are applied to the column electrodes D and scan pulses SP are applied to the row electrodes Y to produce an addressing discharge.

At this point, the grounding wire E and the GND terminal are connected by the switching circuit SW, so that the potential of the metal base 15a of the partition wall member 15 is set at the ground potential.

The wall charges formed in all the discharge cells C by the reset discharge are selectively erased by the addressing discharge. As a result, the light emitting cells (the discharge cells C having the wall charges stored on the dielectric layer 11) and the non-light emitting cells (the discharge cell C in which the wall charges are erased from the dielectric layer 11) are distributed over the panel surface in accordance with an image to be formed.

In the sustaining discharge period Ic subsequent to the addressing period, discharge-sustaining pulses IPx, IPy are applied, simultaneously in all the display lines L, alternately to the row electrode pair (X, Y) to cause a sustain discharge across the discharge gap g between the transparent electrodes Xa and Ya of the row electrode pair (X, Y) in each light emitting cell.

At this point, the grounding wire E and the GND terminal are re-disconnected by the switching circuit SW, so that the potential on the metal base 15a of the partition wall member 15 comes into the floating state.

By means of the sustaining discharge, ultraviolet light is generated from the discharge gas in the discharge space S, and then excites the phosphor layers 16 of the three primary colors, red, green and blue. As a result, the phosphor layers 16 emit light to form the image displayed.

The switching of the switching circuit SW is performed under the control exercised by one of three drivers, row-electrode drivers XD, YD provided for applying the discharge sustaining pulses to the row electrodes X, Y, and an address driver AD provided for applying the data pulse to the column electrode D, as illustrated in FIG. 13, or alternatively by a circuit-only driver (not shown).

With this method of driving the PDP, because the partition wall member 15 is maintained at the ground potential during the addressing period Wc in each subfield, the metal base 15a of the partition wall member 15, i.e., a conductive substance is unlikely to have a potential by means of the addressing discharge.

In consequence, the occurrence of a false discharge in another discharge cell C in the vicinity of the discharge cell C undergoing the addressing discharge is prevented.

Further, because the partition wall member 15 is fixed at the ground potential and therefore is not varied in potential with the number of discharge cells C subject to the addressing discharge (i.e. the number of selected discharge cells C), the kinds of the discharge cells C (i.e. the colors of the phosphor layers 16) selected in accordance with the combinations of red, green and/or blue colors for reproducing various colors, and the like. Accordingly, the decrease in the addressing-voltage margin (Vofs margin) which is caused by using the metal base 15a to form the partition wall member 15 is prevented.

Still further, with the method of driving the PDP, in each subfield the partition wall member 15 is in the floating state during the reset period Rc and the sustaining-discharge period Ic, but is brought into a potential state by means of the sustaining discharge. Hence, the potential difference between the partition wall member 15 and the row electrodes X, Y individually receiving the application of the discharge-sustaining pulses IPx, IPy is decreased. Because of this decrease, most of the discharge electric current flows from one of the row electrodes X, Y receiving the application of the discharge sustaining pulse to the other row electrode receiving no application of the discharge sustaining pulse.

As a result, a large sustaining-voltage margin (Vsus margin) is obtained in the sustaining discharge, and reactive power dissipation is reduced to achieve the high-efficiency light emission from the panel.

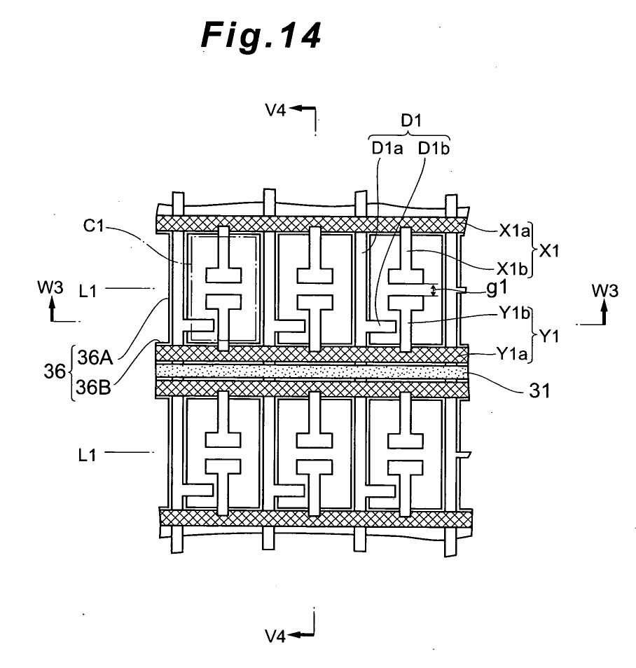

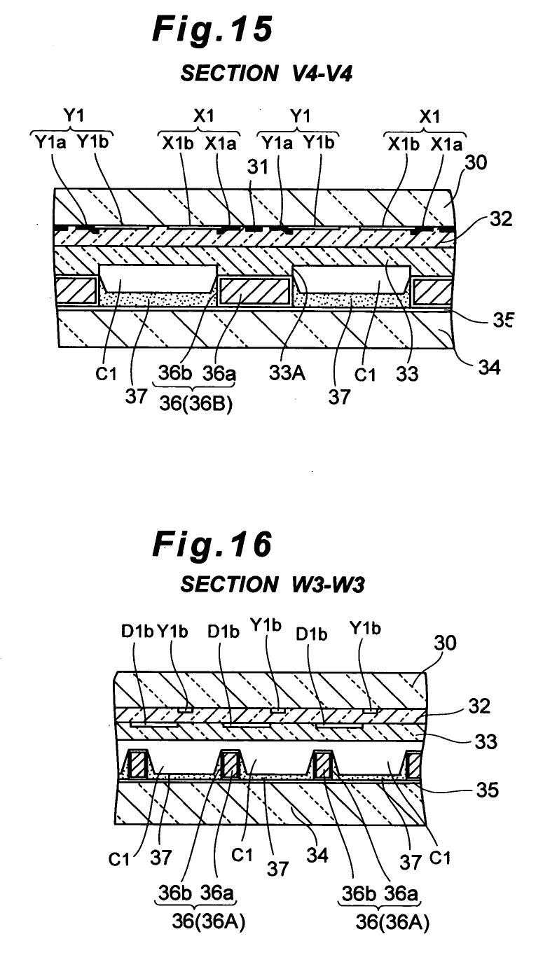

The foregoing driving method for the PDP is applicable to a PDP having the row electrode pairs and the column electrodes provided on the front glass substrate as illustrated in FIGS. 14 to 16, as well as the foregoing PDP having the row electrode pairs (X, Y) provided on the front glass substrate 1 and the column electrodes D provided on the back glass substrate 13.

Specifically, the PDP shown in FIG. 14 to 16 has the front glass substrate 30 on the rear-facing face of which row electrode pairs (X1, Y1) are arranged in plurality parallel to each other and each extend in the row direction of the front glass substrate 30 (i.e. the right-left direction in FIG. 14).

The row electrode X1 is composed of a black- or dark-colored bus electrode X1a formed of a metal film extending in the row direction of the front glass substrate 30, and T-shaped transparent electrodes X1b formed of a transparent conductive film made of ITO or the like. The transparent electrodes X1b are lined up along the bus electrode X1a at regular intervals, and connected to the bus electrode X1a at the proximal ends (corresponding to the foot of the T shape) thereof.

Likewise, the row electrode Y1 is composed of a black- or dark-colored bus electrode Y1a formed of a metal film extending in the row direction of the front glass substrate 30, and T-shaped transparent electrodes Y1b formed of a transparent conductive film made of ITO or the like. The transparent electrodes Y1b are lined up along the bus electrode Y1a at regular intervals, and connected to the bus electrode Y1a at the proximal ends (corresponding to the foot of the T shape) thereof.

The row electrodes X1 and Y1 are arranged in alternate positions in the column direction of the front glass substrate 30 (i.e. the vertical direction in FIG. 14). The transparent electrodes X1b and Y1b which are lined up along the corresponding bus electrodes X1a and Y1a in each row electrode pair at regular intervals extend in the direction toward its counterpart in the row electrode pair, such that the two distal widened-ends (corresponding to the head of the T shape) of the transparent electrodes X1b and Y1b face each other with a discharge gap g1 having a required width in between.

Black- or dark-colored light absorption layers (light-shield layers) 31 are further provided on the rear-facing face of the front glass substrate 30. Each of the light absorption layers 31 extends in bar form in the row direction along and between the back-to-back bus electrodes X1a and Y1a of the row electrode pairs (X1, Y1) adjoining to each other in the column direction.

The row electrode pairs (X1, Y1) and the light absorption layers 31 are covered with a first dielectric layer 32 formed on the rear-facing face of the front glass substrate 30.

Column electrodes D1 each extending in the column direction are arranged in plurality at regular intervals in the row direction on the rear-facing face of the first dielectric layer 32.

Each of the column electrodes D1 is composed of a strip-shaped column-electrode body D1a and strip-shaped column-electrode discharge portions D1b. The column-electrode body D1a extends in a direction at right angles to the bus electrodes X1a, Y1a (i.e. in the column direction), and is located opposite a strip extending through mid-positions between the adjacent transparent electrodes X1b and the adjacent transparent electrodes Y1b which are regularly spaced along the corresponding bus electrodes X1a and Y1a of the row electrodes X1 and Y1 in the row direction. Each of the column-electrode discharge portions D1b is formed integrally with the column-electrode body D1a and extends from the long side of the column-electrode body D1a in the row direction in each display line Ll. The leading end of the column-electrode discharge portions D1b is positioned behind the distal widened-end of the transparent electrode Y1b in the vicinity of the connection between the transparent electrode Y1b and the bud electrode Y1a when viewed from the front glass substrate 30.

The column-electrode bodies D1a and the column-electrode discharge portions D1b of the column electrodes D1 are covered with a second dielectric layer 33 formed on the rear-facing face of the first dielectric layer 32.

Strip-shaped additional dielectric layers 33A protrude from the rear-facing face of the second dielectric layer 33 toward the rear of the PDP. Each of the additional dielectric layers 33A extents along the back-to-back bus electrodes X1a, Y1a in the row direction in a position opposite to the back-to-back bus electrodes X1a and Y1a of the adjoining row electrode pairs (X1, Y1) and to the light absorption layer 31 provided between the back-to-back bus electrodes X1a and Y1a concerned.

An MgO-made protective layer (not shown) is laid on the rear-facing faces of the second dielectric layer 33 and the additional dielectric layers 33A.

The rear-facing face of the front glass substrate 30 faces parallel to a back glass substrate 34 with a discharge space in between.

A third dielectric layer 35 is provided on the front-facing face of the back glass substrate 34 facing toward the front substrate 30.

On the third dielectric layer 35, a partition wall member 36 is provided and constituted by covering the entire surface of a metal-made base 36a with an insulation layer 36b.

The partition wall member 36 is formed in a grid shape constituted of strip-shaped vertical walls 36A each extending in the column direction opposite the column-electrode body D1a provided on the front glass substrate 30, and strip-shaped transverse walls 36B each extending in row direction opposite the back-to-back bus electrodes X1a and Y1a of the adjoining row electrode pairs (X1, Y1) and opposite the light absorption layer 31 positioned between the back-to-back bus electrodes X1a and Y1a concerned.

The partition wall member 36 partitions the discharge space defined between the front glass substrate 30 and the back glass substrate 34 into areas each facing the column-electrode discharge portion D1a and the paired transparent electrodes X1b and Y1b in each row electrode pair (X1, Y1), to define discharge cells C1.

In each display discharge cell C1, a phosphor layer 37 is laid on all five faces facing the discharge space, i.e. the front-facing face of the back glass substrate 34 and the side faces of the vertical walls 36A and the transverse walls 36B of the partition wall member 36. The three primary colors, red (R), green (G) and blue (B) are applied individually to the phosphor layers 37 such that the red (R), green (G) and blue (B) discharge cells C1 are arranged in order in the row direction.

The discharge space between the front glass substrate 30 and the back glass substrate 34 is filled with a discharge gas including xenon Xe.

The PDP described in FIGS. 14 to 16 is driven by the use of the method of driving a PDP according to the present invention. When an addressing discharge is caused between the transparent electrode Y1b of the row electrode Y1 and the column-electrode discharge portion D1b of the column electrode D1, the metal base 36a of the partition wall 36 is grounded via a grounding wire (not shown) so that the potential on the partition wall 36 is set at the ground potential.

When a reset discharge and a sustaining discharge are caused between the row electrodes X1 and Y1, the metal base 36a of the partition wall member 36 is disconnected from the ground so as to come into a floating state.

The foregoing embodiment has described the examples in which the potential of the partition wall is set at a ground potential on the full panel surface during the addressing period, but is not limited to the examples. The potential of the partition wall may be set at a predetermined potential, e.g. a predetermined direct potential, on the full panel surface during the addressing period.

The embodiment has described a method of driving a PDP based on the superior idea that: for driving a plasma display panel comprising a pair of substrates facing each other with a discharge space in between, a plurality of row electrode pairs, a plurality of column electrodes arranged to intersect with the row electrode pairs, and a partition wall member provided for defining unit light emission areas each formed in the proximity of the intersection of the row electrode pair and the column electrode in the discharge space, the partition wall member being formed of a metal-made base material covered with an insulation layer, the driving method comprises a step of setting a potential on the metal-made base material of the partition wall member at a predetermined potential during an addressing period of an image display period, in which an addressing discharge is produced by the application of a scan pulse to one row electrode in the row electrode pair and the application of a data pulse to the column electrode to select the unit light emission areas in which a sustaining discharge is to be produced in order to emit light for the generation of an image.

In this method of driving a plasma display panel based on the superior idea, the partition wall member of the plasma display panel, which is provided for defining the unit light emission areas formed in the discharge space between the pair of substrates, is made of a metal-made base covered with an insulation layer. After the completion of the reset discharge, during the addressing discharge period of the image display period, a scan pulse is applied to one row electrode in the row electrode pair and a data pulse is applied to the column electrode in order to select the unit light emission areas in which a sustaining discharge is to be produced for the creation of an image by means of the discharge emission. During this addressing discharge period, the metal-made base of the partition wall member is grounded so that the potential on the partition wall member is set at a predetermined potential.

With this method of driving the plasma display panel, because the potential on the partition wall member is set at a predetermined potential during the addressing period of the image display period, the potential on the partition wall member becomes equal over the entire panel surface, resulting in the prevention of the occurrence of a false discharge in another unit light emission area in the vicinity of the unit light emission area in which the addressing discharge is produced.

Further, because the potential on the partition wall member is set at a predetermined potential and therefore is not varied in potential with the number of unit light emission areas subject to the addressing discharge (i.e. the number of selected unit light emission areas), the kind of unit light emission area (i.e. the color of the phosphor layer) selected in accordance with the combinations of red, green and/or blue colors for reproducing various colors, and the like. Accordingly, the decrease in the addressing-voltage margin which is caused by using a metal-made base to form the partition wall member is prevented.

The terms and description used herein are set forth by way of illustration only and are not meant as limitations. Those skilled in the art will recognize that numerous variations are possible within the spirit and scope of the invention as defined in the following claims.

What is claimed is:

1. A method of driving a plasma display panel provided with a pair of substrates facing each other with a discharge space in between, a plurality of row electrode pairs, a plurality of column electrodes arranged to intersect with the row electrode pairs, and a partition wall member provided for defining unit light emission areas each formed in the proximity of the intersection of the row electrode pair and the column electrode in the discharge space, the partition wall member being formed of a metal-made base material covered with an insulation layer, the method of driving the plasma display panel comprising a step of setting a potential on the metal-made base material of the partition wall member at a predetermined potential during an addressing period of an image display period, in which an addressing discharge is produced by application of a scan pulse to one row electrode in the row electrode pair and application of a data pulse to the column electrode to select the unit light emission areas in which a sustaining discharge is to be produced in order to emit light for generation of an image.

2. A method of driving the plasma display panel according to claim 1, further comprising a step of bringing the potential on the metal-made base of the partition wall member into a floating state during a reset period of the image display period, in which a reset discharge is produced simultaneously in all the unit light emission areas before the addressing discharge is produced.

3. A method of driving the plasma display panel according to claim 1, further comprising a step of bringing the potential on the metal-made base of the partition wall member into a floating state during a sustaining discharge period of the image display period, in which a sustaining discharge is produced in the unit light emission areas selected by means of the addressing discharge for emission of light to generate the image.

4. A method of driving the plasma display panel according to claim 1, wherein the addressing discharge is caused between one row electrode in the row electrode pair provided on one of the pair of substrates and the column electrode provided on the other substrate.

5. A method of driving a plasma display panel according to claim 1, wherein the addressing discharge is caused between one row electrode in the row electrode pair and the column electrode both provided on one of the pair of substrates.
